(19) United States
(12) Patent Application Publication
(10) Pub. No.: US 2005/0216109 A1
(43) Pub. Date: Sep. 29, 2005

(54) Integrated precision machine design system and method

(76) Inventors: Thomas J. Radigan, Bedford, MA (US); Harrison H. Chin, Bedford, MA (US)

Correspondence Address: MESMER & DELEAULT, PLLC, 41 BROOK STREET, MANCHESTER, NH, 03104, US

(21) Appl. No.: 10/907,288

(22) Filed: Mar. 28, 2005

Related U.S. Application Data
(60) Provisional application No. 60/557,215, filed on Mar. 29, 2004.

(51) Int. Cl. G06F 19/00

(52) U.S. Cl. 700/97

(57) ABSTRACT

An integrated precision machine design system includes an intelligent processing module, a parts database module coupled to the processing module, a training materials database module coupled to the processing module, and program code configured for receiving a user-specified precision machine design specification where the program code is operably coupled to the processing module to compute design system properties using data from the parts database module based on the user-specified precision machine design specification.

This application claims benefit of U.S. Provisional Application No. 60/557,215, filed Mar. 29, 2004.

### BACKGROUND OF THE INVENTION

1. Field of the Invention

The present invention relates generally to precision machine design. Particularly, the present invention relates to an integrated system and method in precision machine design that facilitates both the training and design process.

2. Description of the Prior Art

There have been various knowledge-based engineering systems devised to date to help the engineer design specific products. These knowledge-based engineering systems are used for specific applications such as gear design, HVAC air-handling assemblies for a climate control system, variable speed AC motors, machinery component selection, component placement system for circuit board components, structural members for a building frame, power supplies, etc. Although knowledge-based systems have been devised, these have been very specific and fail to address the needs of the precision motion control industry.

Over the last three decades automated manufacturing has become vital to the U.S. economy. Producing goods by automated methods has allowed U.S. companies to remain competitive in the global marketplace by increasing productivity (output per worker) and quality. In many cases, goods cannot be manufactured without the use of automated manufacturing lines.

Integrated circuits, data storage devices, printed circuit boards and flat panel displays are just some of the technology products that require automated production because of features size, throughput and cleanliness. To produce these technology products and others with precision processes, a wide range of capital equipment is required. The precision capital equipment market can be broken down into various segments including, but not limited to, machine tools, metrology, printed circuit board, semiconductor, data storage, flat panel, fiber optic communications, biotechnology, digital imaging, nanotechnology, factory automation, etc. The largest market segment is the semiconductor capital equipment market, which is estimated to exceed 25 billion dollars with an annual growth rate of close to 20% in 2004 and 2005.

This diverse group of industries in the precision capital equipment market has significantly different characteristics. While the primary focus of each segment is on their respective process, there is one common requirement shared by all. To achieve the process goals, precision automation is always required. The automation complexity, however, varies significantly as does the process requirements.

The development of precision automation equipment often requires a range of technical expertise from engineering (mechanical, electrical and optical) to computer science. The basic knowledge requirements are thus quite varied but usually include subjects such as precision machine design, mechanical vibrations, control system design, and the understanding of components such as motors, drives, actuators, feedback sensors and controls. In essence, the skill set is broad (electromechanical) with an understanding of very specific design methodologies such as precision engineering.

To gain these specialized skills, U.S. engineers typically rely on a number of sources. These sources include (1) colleges and universities, (2) industry books, journals and magazines, (3) industry seminars and (4) supplier catalogs. Maximum productivity would be obtained from the U.S. engineer if the required knowledge was obtained at the college or university level with little or no on-the-job training. However, this is rarely the case. Many schools still have separate curriculums for mechanical and electrical engineering. Also, courses that teach relevant design methodologies are not uniform between schools and availability is usually at the graduate level, if at all. Thus, the engineer that obtains a degree from a U.S. institution often does not have the required skill set for an employer in the precision capital equipment market. On-the-job training can be provided by the employer but at a cost in lost efficiency and productivity.

Once the skill set is developed, the engineer must then develop spreadsheets or use software programs such as Matlab®, Simulink® and Mathcad® to perform repetitive or complex design tasks and then sift through various supplier catalogs for components with the proper specifications. This design process, while currently necessary, again comes at the cost of lost efficiency and productivity. While industry information is plentiful, it can be time consuming to gather and take years to truly understand.

In addition to the above problems, the industries typically follow a cyclical business pattern and often lose highly trained workers during downturns through layoffs and attrition.

Therefore, what is needed is a system and method that integrates the precision automation design tasks. What is further needed is a system and method that will help maintain the competitive advantage of companies in the global marketplace. What is also further needed is a system and method that facilitates both the training of engineers and the designing function for engineers.

### SUMMARY OF THE INVENTION

It is an object of the present invention to provide a system and method that brings the knowledge of precision machine design into an integrated and intelligent environment for practicing engineers and engineering students. It is another object of the present invention to provide a system and method to enable engineers and engineering students to perform various simulations and optimizations. It is still another object of the present invention to provide a system and method that will provide a competitive advantage in the global marketplace by increasing engineering productivity and reducing machine development time and costly errors.

The present invention achieves these and other objectives by providing an integrated precision machine design system and method that includes an intelligent processing module, a parts database module, an electronic training materials database module, and a graphical user interface module. The system enables one to perform various simulations and optimizations to suit a specific product design.

The electronic training materials database module (ETM database) contains both basic and state-of-the-art precision machine design information and theories such as control theory, machine vibrations, etc. The ETM database allows users to retrieve relevant information and applicable theories for particular design applications.

The parts database module contains a list of commercially available parts specifications. Entries in the parts database can be added and updated to include customized parts. The parts database is also capable of searching and updating parts information through an electronic network such as local area network, a wide area network, the Internet, etc. Although the data model for the parts database uses industry-standard terminology and nomenclature, it is not dependent on terminology and data specific to a particular application. The parts database utilizes a hierarchical data structure to provide the ability to optimize and experiment the part, sub-assembly, assembly, sub-system, and/or system level design.

The intelligent processing module performs all the necessary computation, modeling, and simulation at part/assembly/system levels as well as information retrieval from the parts database and the ETM database according to user input. Regarding computation, the intelligent processing module will compute various properties using data from the parts database. The various properties are categorized into various design systems such as mechanical system design, electrical system design and control system design.

Under the mechanical system design, the intelligent processing module will compute system error budgets, bearing selection and sizing, mechanical drive selection and sizing, vibration isolation selection, kinematic mount design, and optical mount design. Under the electrical system design, the intelligent processing module will compute motion profile calculations, motor selection and sizing, amplifier selection and sizing, and feed back selection. With regard to control system design, the processing module will determine model transfer functions, open/closed loop frequency response (phase/gain margins, resonant frequencies, etc.), tuning parameters, filter recommendations, transient response (step, ramp, motion profile, etc.) and disturbance/noise rejection. The intelligent processing module allows the user to create/modify a model based on actual frequency response measurements or from a finite element analysis model, and to perform various simulations using the model. Further, the intelligent processing module recommends possible corrective actions based on the simulation results.

The graphical user interface module (GUI) is the front end of the integrated precision machine design system that accepts and relays various user inputs to the intelligent processing module and displays results. The GUI provides access to configuration and parts information by way of searches and includes, but is not limited to, the display of information and selection options such as, for example, a status window, a chart window, a model window, a command window, tool icons window, etc.

The method employed by the present invention is useful both for training engineers and for facilitating the design, modeling and optimizing functions of precision machine development engineers. The method includes the ability of the engineer or engineering trainee to query the electronic training database. The method begins with the engineer or engineering trainee receiving specifications for a precision machine. The engineer either understands the specifications, in which case he then selects between either a system level or a component level specification, or, if the engineer does not understand what technologies are available for use in meeting the specifications, the engineer may query the electronic training database by topic or application. A list of descriptions of technical specifications is selected by the system in response to the query. The list may include general industry information to specific information relating to use of the present invention. This list will help the engineer or engineering trainee understand the available technologies to meet the specifications.

Once the engineer or engineering trainee understands the available technologies for the particular specification, the user must select to proceed at the system level specification or the component level specification. The component level specification would likely be used when the engineer or engineering trainee only needs a particular component in the design they are working on. The user would select the type of component, input the parameters relative to the application or the specification and then query the parts database. The present invention generates a list of parts that meet the requirements/parameters inputted by the user.

The user then has the option of comparing all of the parts on the list or comparing only a limited selection from the list. After making a comparison selection, the user may then select to run an optimization sequence. If the user does not want to optimize, a report is then provided to the user. If the user does want to optimize, the user must then select the feature and/or characteristic to optimize. The present invention displays the result of the optimization process and provides the user the option of optimizing a different feature and/or characteristic. If the user does not wish to optimize a different feature, the present invention then provides a report to the user.

Selecting the system level specification is likely chosen when a system specification must be achieved. If selected, the user is then requested to input the system level information. As described above, the present invention queries the user as to the user's understanding of the specification. The user has the choice of querying the electronic training materials database by topic or application for a list of descriptions of technical information. The list generated by the present invention includes not only general industry information but also specific industry information and information specific to the use of the present invention.

Whether the user opts out of querying the electronic training database or not, the user then must select the system level specifications. Once the system level specification is chosen, the user then must select the type of component. In the process of selecting the type of component, the user must also indicate how the parameters specific to the application will be provided. There is a plurality of choices available to the user including, but not limited to, using the information/parameters previously provided when the system level information was requested, inputting of the parameters by the user, searching for a particular component/part, etc. The parameters are used by the present invention to query the parts database and a list of parts meeting the requirements is generated.

Because the user is in the system level branch of the present invention, the present invention then models/simulates the system using the list of parts that were generated. The user has the option after the modeling/simulation to optimize the system or not. If optimization is declined, the present invention generates a report for the user disclosing one or more models obtained during the modeling/simulation step. If optimization is selected, the user then selects whether the optimization is to occur at the system or component level.

Whichever type of optimization is chosen, the user must input the optimization parameter. The present invention receives the optimization parameter and provides a result based on the chosen optimization parameter. The user then has the option to optimize a different parameter or not. If further optimization is declined, the present invention provides a report. If further optimization is performed, the user then selects again whether it is a system or component level optimization and inputs the new optimization parameter. A new optimization result is provided to the user based on the new optimization parameter. Once the user is finished with optimizing, a report is generated that may include one or more of the optimizations performed by the user.

### BRIEF DESCRIPTION OF THE DRAWINGS

FIG. 1 is block diagram showing an overview of the present invention.

FIG. 2 is an illustration of one example of a model used by the present invention for system modeling.

FIG. 3 is an illustration of a ballscrew assembly example within the electronic training materials database of the present invention.

FIG. 4 is a block diagram of the parts database hierarchy of the present invention.

FIG. 5 is an illustration of the present invention showing a component level selection made by a user.

FIG. 6 is an illustration of the present invention showing a system level selection made by a user.

### DETAILED DESCRIPTION OF THE PREFERRED EMBODIMENT

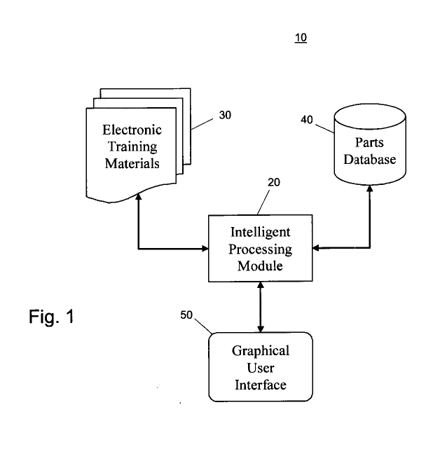

The preferred embodiment of the present invention is illustrated in FIGS. 1-6. FIG. 1 is a block diagram illustrating the major components of an integrated precision design system 10. Integrated precision design system 10 includes an intelligent processing module 20, an electronic training materials database module 30, a parts database module 40, and a graphical user interface module 50. Intelligent processing module 20 has two-way communication/data transfer with the electronic training materials database module 30, the parts database module 40 and the graphical user interface module 50. Using the above components, the present invention provides a method and apparatus for training engineers in precision machine development and for facilitating precision machine development engineers in designing precision machines to predefined specifications. Predefined specifications mean the machine requirements that must be met in order to meet the industry process requirements.

Intelligent processing module 20 either contains program code developed from proven machine design and motion control theories or is operably coupled to program code developed from proven machine design and motion control theories. Intelligent processing module 20 performs all the necessary computation, modeling, and simulation at various levels including, for example, at part, assembly, and system levels. Intelligent processing module 20 also provides information retrieval. Specifically, intelligent processing module 20 is enabled to compute various properties using data from parts database module 40. The various properties are grouped into four categories; mechanical system design, electrical system design, control system design, and advanced features.

Mechanical system design includes system error budgets such as, for example, single to multi-axis configurations, bearing selection and sizing (for example, linear guide, crossed roller, linear bushing, double V, air bearings, flexures, etc.), mechanical drive selection and sizing (for example ballscrew/leadscrew, belt, rack and pinion, friction, etc.), vibration isolation, kinematic mount design, and optical mount design. The electrical system design includes motion profile calculations (for example S-curve profiling), motor selection and sizing (for example, rotary, direct drive linear, stepped, brushed DC, bruschless DC, voice coil, piezo, AC), amplifier selection and sizing (for example, unipolar, bipolar, pulse width modulated, and linear), and feedback selection.

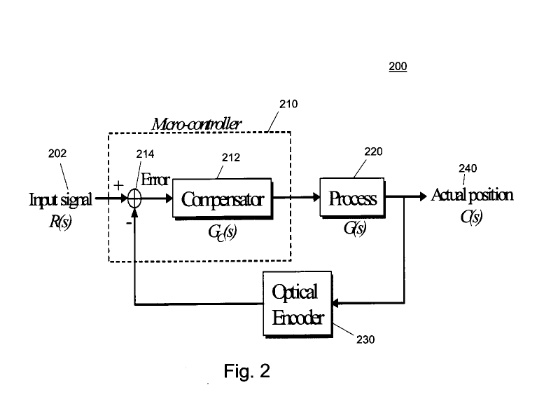

Turning now to FIG. 2, there is illustrated one example of a model and the modeling that the intelligent processing module 20 contains. FIG. 2 shows a control model 200 for a precision position control system using an optical encoder as the sensor. Control model 200 includes a controller reference signal input 202, a micro-controller 210, a plant 220, a feedback device 230, and an actual position result 240. Controller signal input 202 receives a reference signal that represents a position along the position control system. Micro-controller 210 incorporates a compensator 212 that contains a control algorithm such as for example a proportional integral derivative controller, and an error signal input 214. Error signal input 214 receives a signal from feedback device 230 that relays the actual position to micro-controller 210. Feedback device 230 may be a position feedback device such as for example an optical encoder, or other feedback devices such as a tachometer, resolver, rotary encoder, linear variable differential transformer, linear encoder, laser, etc. Micro-controller 210, using the control algorithm, compensates and moves the plant 220 to the actual position that the reference signal represents. Plant 220 is the mechanical element whose position the controller reference signal is trying to control.

Intelligent processor module 20 also allows a user to create/modify a model based on, for example, actual frequency response measurements or from a finite element analysis model, and to perform various simulations using the model. Some examples include simulating mode shapes and vibration responses, calculating statistical properties based on a number of noise-contaminated inputs, identifying weak links in the system, etc.

Based on the simulation results, intelligent processor module 20 will recommend possible corrective actions. For example, in high resolution imaging applications, the image quality is affected by the lowest resonances that may overlap common frequencies known to exist in the tool environment. Usually resonances below 120 Hz can be very detrimental to image quality since they coincide with most common cleanroom noise sources (i.e., 50-60 Hz, etc). While an exact value depends on the tool sensitivity and site survey, a realistic target is for all structural resonances to be greater than 150 to 200 Hz. To meet this target the following components in the optics-specimen structural loop should be examined carefully: (1) Support structure for imaging optics, (2) Support structure for positioning system and (3) Positioning system and wafer carrier. Possible solutions to the problem include: increase stiffness, decrease mass, increase damping or a combination of all three.

Electronic training database module 30 contains both basic and state-of-the-art precision machine design information and theories such as control theory, machine vibrations, etc. It will also contain information on how to use the present invention. The purpose of the electronic training database module 30 is to help design engineers and students retrieve relevant information and applicable theories for particular design applications. The electronic training database module 30 includes hyperlinked text for easy access and for searching the information.

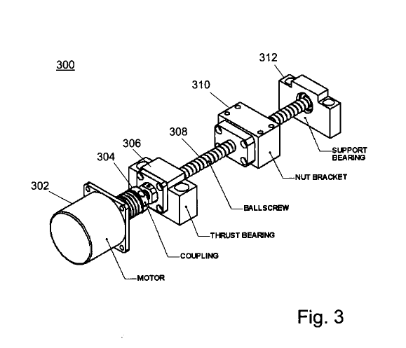

FIG. 3 illustrates one example of the kind of information stored in the electronic training database module 30. FIG. 3 shows a ballscrew drive assembly 300. Ballscrew drive assembly 300 includes a motor 302, a coupling 304, a thrust bearing 306, a ballscrew 308, a nut bracket 310, and a support bearing 312. In order to calculate the axial resonance, the ballscrew drive assembly 300 can be modeled as a number of springs in series with the assumption that the ballscrew drive assembly 300 behaves like a second order mass damper spring system. Based on these assumptions, the axial resonance can be calculated using the following formulas:

$${K}_{t} = \frac{1}{\frac{1}{{K}_{bb}} + \frac{1}{{K}_{b}} + \frac{1}{{K}_{s}} + \frac{1}{{K}_{n}} + \frac{1}{{K}_{nb}}}$$

$${F}_{ar} = \frac{1}{2 π} \sqrt{\frac{{K}_{t}}{m}}$$

where
   Kₜ=total drive stiffness (N/m)
   K_{bb}=bearing mount stiffness (N/m)
   K_{b}=thrust bearing stiffness (N/m)
   Kₛ=screw shaft stiffness (N/m)
   Kₙ=ballscrew nut stiffness (N/m)
   K_{nb}=nut bracket stiffness (N/m)
   m=payload mass (Kg)
   Far=axial resonance (Hz)

Parts database module 40 contains a list of commercially available parts specifications that are precompiled for easy use. Based on user specified design considerations and constraints, parts database module 40 will perform an optimal search within the database and produce a list of desirable parts that satisfy the performance criteria. Entries in the parts database module 40 can be added or updated to include customized parts.

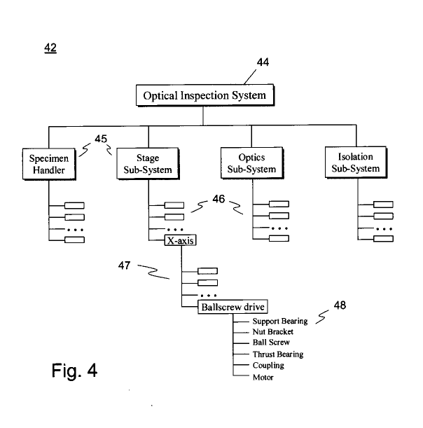

Parts database module 40 utilizes a hierarchical data structure. In FIG. 4, an optical inspection system is used as an example to illustrate the hierarchical data structure 42 used by the parts database 40. As can be seen in FIG. 4, the optical inspection system level 44 is an upper level in the data structure with one or more sublevels 45, 46, 47, and 48. Since parts database module 40 utilizes a hierarchical data structure, it is possible to optimize and experiment the part, sub-assembly, assembly, sub-system, and/or system level design. For example, if an instrument requires less than 1 micro-meter resonance from the x-axis, parts database module 40 will search the database and recommend a list of possible part combinations that can meet this requirement.

Parts database module 40 utilizes a Structured Query Language (SQL) compatible database management system that can function in a networked, client/server architecture, as a stand-alone, and to support future development/extension of the present invention. The data model in the parts database module 40 uses industry-standard terminology and nomenclature. The data model is implementable without dependency on the terminology and data specific to a particular application. The data model is capable of supporting the use of multiple assemblies in any slot in the assembly/sub-assembly configuration. The data model further provides mechanisms to validate data such as part numbers, serial numbers, specifications, etc. In addition, parts database module 40 will have the ability to search and update parts information and specifications through an ethernet connection. Furthermore, parts database module 40 can optionally perform part/system level optimization based on user supplied criteria.

Graphical user interface module 50 is the front end of the integrated precision design system 10. It relays various user inputs to the intelligent processing module 20, and displays results. Graphical user interface module 50 is intuitive for use by engineering students and engineers. It incorporates an efficient work/process flow and clear presentation of data that could reasonably be expected to be understood by engineering students and engineers without significant retraining. To facilitate the learning curve, the graphical user interface module 50 uses a hierarchical display similar to the MS Windows Explorer menu tree structure wherever hierarchical displays are appropriate.

Graphical user interface module 50 includes exception handlers to trap and identify error conditions and return control to the user interface. It further includes hyper-text context sensitive on-line help/user's manual. In addition, graphical user interface module 50 provides a proactive user interface which provides assistance to lead the user through various standard procedures and business processes. Other features of the graphical user interface module 50 include consistent use of commands (e.g. scroll with mouse on all windows or with arrow keys on all windows), a consistent approach to handling user input, handling errors, and presenting information to the user, keyboard shortcuts for all mouse-initiated events, the capability to print any screen which displays a report or graph, access to configuration and parts information by way of a drill-down hierarchy beginning at the organizational level, the capability to obtain configuration and parts information by way of searches based on part number, type, manufacturer, etc., provide text boxes or fields for the entry of all data, verification on all data entered into text entry fields such that invalid contents will not adversely impact the operation of the system, notification to the user and require a correction whenever an invalid entry is detected, etc.

Those skilled in the art will realize that the functionality of the present invention can be distributed over a single computer acting as a central integrated machine design system or over a plurality of computers. Those skilled in the art will also realize that the present invention may also be distributed in a program product that contains all of the essential software modules of the present invention. One skilled in the art will appreciate that the present invention may also be used over the Internet and that an almost unlimited number of users may be supported. This arrangement yields a more dynamic and flexible system, less prone to catastrophic hardware failures affecting the entire system. Those skilled in the art will also recognize that the present invention may be practiced using an off-line embodiment.

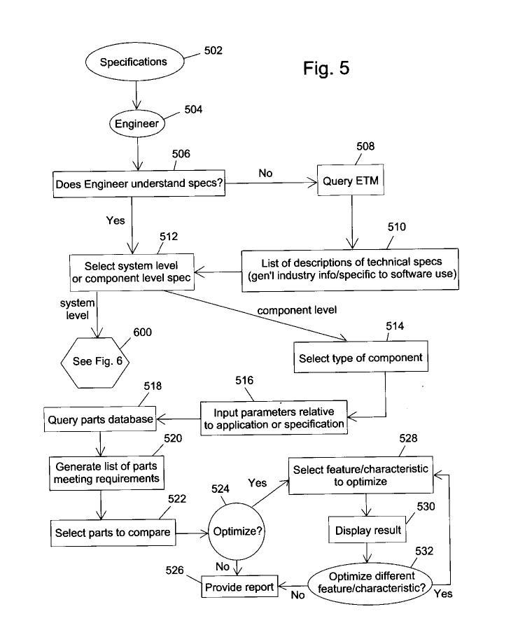

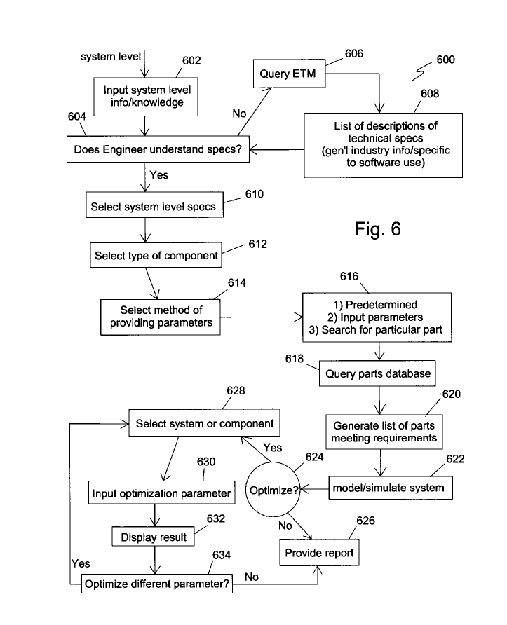

In the preferred embodiment, the system is initialized by a user such an engineer or an engineering student. The engineer or engineering student typically has a set of precision machine development specifications. Turning now to FIGS. 5 and 6, there is a graphical illustration of the process of the present invention.

In FIG. 5, the process begins with the user 504, i.e. engineer or engineering trainee/student, receiving specifications 502 for a precision machine. The process queries the user at step 506 whether the user understands the specifications. In other words, the process is questioning the user if the user knows what technologies are available for use in meeting the specifications. The user chooses either “yes” or “no.” If the user chooses “No,” the user queries the electronic training database module 30 at 508 by topic or application. A list of descriptions of technical specifications are selected by the system at 510 and displayed to the user in response to the query. The list may include general industry information to specific information relating to use of the present invention. This list helps the user understand the available technologies to meet the specifications.

Once the user understands the available technologies for the particular specification, the user must select at step 512 to proceed at the system level specification or the component level specification. The component level specification would likely be used when the user only needs a particular component in the design he/she is working on. If the user selects a component level specification at 512, then the user must select the type of component at 514 followed by inputting the parameters relative to the application or specification at 516, and then querying the parts database at 518. Parts database module 40 generates a list of parts meeting the requirements at 520 and presents the list to the user, allowing the user to select the parts to compare at 522. The user may select all of the parts to compare or to compare only a limited selection from the list.

At this point in the process, the user has the option of optimizing the parts selection at 524. If the user does not want to optimize the parts selection, the process then provides the user with a report at 526. On the other hand, if the user does optimize at 524, the user must then select the feature and/or characteristic he/she wants optimized at 528. Upon inputting the selecting feature and/or characteristic to optimize, the system performs the optimization analysis and displays the results to the user at 530. The user has the option at this point in the process to further optimize based on a different feature and/or characteristic at 532, which brings the user back to step 528 to select the feature and/or characteristic to optimize, or to finish and obtain a report at step 526.

Back at step 512, if the user selects the system level specification 600, a different set of options are presented. FIG. 6 illustrates the process when the system level specification is selected. At step 602, the user is requested to input the system level information/specification. Examples of system level configurations include single axis (linear, rotary, etc.) and multi-axis (compound, gantry, split, robot, etc.). Examples of system level performance criteria include frequency response (phase/gain margins, resonant frequencies, etc.), tuning parameters, filter recommendations, transient response (step, ramp, motion profile, etc.), disturbance/noise rejection, accuracy and repeatability, etc. At step 604, the user again has the option of requesting help in understanding the available technologies that could be used in the system design. In this particular embodiment, the process asks the user if he/she understands the specifications and the technologies required. If the user answers “No,” a query is formulated by the user and the electronic training database module 30 is queried by topic or application at 606. A list of descriptions of technical specifications are selected by the system at 608 and displayed to the user in response to the query. The list may include general industry information to specific information relating to use of the present invention.

Whether the user opts out of querying the electronic training database or not at step 604, the user then must select the system level specifications at 610. Once the system level specification is chosen, the user then must select the type of component at 612. In the process of selecting the type of component, the user must then indicate how the parameters specific to the application will be provided at 614. The process presents a list of available choices available to the user at 616. The choices include, but are not limited to, using the information/parameters previously provided when the system level information was requested, inputting of the parameters by the user, searching for a particular component/part, etc. Once the parameters are provided, the parts database module 40 is queried at 618. At 620, a list of parts meeting the requirements is generated.

Because the user is in the system level branch of the present invention, the present invention then models/simulates the system at 622 using the list of parts that were generated for the system. At step 624, the user has the option after the modeling/simulation to optimize the system or not. If optimization is declined, the present invention generates a report for the user at 626 disclosing one or more models obtained during the modeling/simulation step. If optimization is selected, the process then requires the user at 628 to select whether the optimization is to occur at the system or component level. Once the user selects the type of optimization, the user then inputs the optimization parameter at 630. At 632, the results based on the chosen optimization parameter are displayed to the user. The user, at 634, then has the option to optimize a different parameter or not. If further optimization is declined, the process provides a report at 626. If further optimization is selected by the user, then the process loops back to step 628 where the user then selects again whether it is a system or component level optimization and inputs the new optimization parameter. A new optimization result is provided to the user based on the new optimization parameter. Once the user is finished with optimizing, a report is generated that may include one or more of the optimizations performed by the user.

There are several advantages and/or key features of the present invention over the prior art. The present invention automates complex design tasks, allows review of both system and component level performance, compares multiple design choices simultaneously, optimizes designs based on desired constraints, is easy to use and learn, and other similar advantages. These advantages provide important benefits over the prior art. The benefits include, for example, speed up of machine development and time to market, increase in worker productivity, reduction in costly mistakes, etc.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

1. An integrated precision machine design system for designing a user-specified precision machine, said system comprising:
an intelligent processing module;
a parts database module coupled to said processing module;
a training materials database module coupled to said processing module; and
program code configured for receiving a user-specified precision machine specification and operably coupled to said processing module to compute design system properties using data from said parts database module based on said user-specified precision machine specification.

2. The system of claim 1 wherein said parts database are characterized into one or more system designs selected from the group consisting of mechanical system design, electrical system design and control system design.

3. The system of claim 2 wherein said program code includes program code for computing one or more mechanical system design properties selected from the group consisting of system error budgets, mechanical drive selection and sizing, vibration isolation, kinematic mount design, and optical mount design.

4. The system of claim 2 wherein said program code includes program code for computing one or more electrical system design properties selected from the group consisting of motion profile calculations, motor selection and sizing, amplifier selection and sizing, and feedback selection.

5. The system of claim 2 wherein said program code includes program code for computing one or more control system design properties selected from the group consisting of model transfer functions, open-closed loop frequency response, tuning parameters, filter recommendations, transient response, and disturbance and noise rejection.

6. The system of claim 1 wherein said intelligent processing module contains said program code.

7. The system of claim 1 further comprising a graphical user interface to interact with a user for receiving said user-specified precision machine specification.

8. The system of claim 1 wherein said parts database module contains a table of commercially available parts specifications.

9. The system of claim 1 wherein said training materials database module contains one or more of basic precision machine design information and basic precision machine design theories.

10. The system of claim 1 wherein said training materials database module contains one or more of state-of-the-art precision machine design information and state-of-the-art precision machine design theories.

11. The system of claim 1 wherein said program code further includes precision machine design capabilities.

12. The system of claim 1 wherein said program code further includes precision machine design simulation capabilities.

13. A method for using a computer for facilitating the design, modeling and optimizing functions of precision machine design, said method comprising:
inputting into a precision machine design system having an intelligent processing module, a parts database module, and a training materials database module a user-specified precision machine design specification wherein an intelligent processing module of a precision machine design system queries a parts database and selects a list of parts from said parts database that meet said user-specified precision machine design specification;
retrieving said list of parts from said parts database that meets said user-specified precision machine design specification; and
selecting one or more parts from said list of parts to compare.

14. The method of claim 13 further comprising selecting the type of user-specified precision machine design specification from the group consisting of a system level specification and a component level specification.

15. The method of claim 14 further comprising optimizing the selection of parts.

16. The method of claim 15 further comprising selecting a characteristic to optimize.

17. The method of claim 14 further comprising modeling a precision machine design based on said user-specified precision machine design specification when said type is a system level specification.

18. The method of claim 17 further comprising optimizing said modeled system.

19. The method of claim 18 further comprising selecting an optimizing parameter.

20. The method of claim 13 further comprising querying a training materials database of said precision machine design system for a list of application topics related to said precision machine design specification.

21. A program product comprising:
a computer usable medium having computer readable program code means embodied therein for facilitating the design, modeling and optimizing functions of precision machine development engineers said computer readable program code means in said program product comprising:
computer readable program code means for causing said computer to effect inputting into said computer a user-specified precision machine design specification;
computer readable program code means for causing said computer to effect querying a parts database and selecting a list of parts from said parts database that meets said user-specified precision machine design specification;
computer readable program code means for causing said computer to effect outputting said list of parts from said parts database that meets said user-specified precision machine design specification;
computer readable program code means for causing said computer to effect inputting into said computer user-selected parts from said list of parts to compare; and
computer readable program code means for causing said computer to effect making a report available of said list of parts.

22. The program product of claim 21 further comprising computer readable program code means in said program product for causing said computer to effect inputting into said computer a type of user-specified precision machine design specification selected from the group consisting of a system level specification and a component level specification.

23. The program product of claim 22 further comprising computer readable program code means in said program product for causing said computer to effect optimizing said selection of parts.

24. The program product of claim 23 further comprising computer readable program code means in said program product for causing said computer to effect selecting a characteristic to optimize.

25. The program product of claim 22 further comprising computer readable program code means in said program product for causing said computer to effect modeling a precision machine design based on said user-specified precision machine design specification when said type is a system level specification.

26. The program product of claim 25 further comprising computer readable program code means in said program product for causing said computer to effect optimizing said modeled system.

27. The program product of claim 26 further comprising computer readable program code means in said program product for causing said computer to effect selecting an optimizing parameter.

28. The program product of claim 21 further comprising computer readable program code means in said program product for causing said computer to effect querying a training materials database of said program product for a list of application topics related to said precision machine design specification.
